(19) United States
(12) Patent Application Publication
(10) Pub. No.: US 2022/0263383 A1
(43) Pub. Date: Aug. 18, 2022

(54) OIL-WATER-COOLED ELECTRIC DRIVE ASSEMBLY AND NEW ENERGY AUTOMOBILE

(71) Applicant: Jing-Jin Electric Technologies Co., Ltd., Beijing (CN)

(72) Inventors: Ping YU, Beijing (CN); Jianwen LI, Beijing (CN); Xudong YANG, Beijing (CN)

(21) Appl. No.: 17/635,759

(22) PCT Filed: Oct. 29, 2019
(86) PCT No.: PCT/CN2019/114070

§ 371 Date: Feb. 16, 2022

(30) Foreign Application Priority Data
Sep. 3, 2019 (CN) 201910828484.1

(51) Int. Cl. H02K 9/193; B60K 11/02; H02K 3/24

(52) U.S. Cl. CPC H02K 9/193; H02K 7/116; H02K 3/24; B60K 11/02

(57) ABSTRACT

An electric drive assembly is provided with oil/water dual cooling that includes a motor module, a gearbox module, a water cooling module and an oil cooling module. The oil cooling module has three oil cooling passages, and introduces the lubricating oil in the gearbox into the front and rear windings of the motor, thereby improving the cooling performance of the motor, eliminating the need for a motor shaft oil seal, reducing the cost of the drive assembly and improving the transmission efficiency. The water cooling module cools the motor housing through the motor water jacket, and cools the lubricating oil in the gearbox housing through the heat sink at the bottom of the gearbox, thereby solving the heat dissipation problem when the gearbox operates at high speed constantly, and thus improving the service life and reliability of the gear and bearing.

### TECHNICAL FIELD

The present disclosure relates to the field of electric drive assembly manufacturing, in particular to an electric drive assembly with oil/water dual cooling and a new energy vehicle.

### BACKGROUND

As the problems such as oil shortage, air pollution and national energy security become getting worse, the new energy vehicle industry is developing rapidly. As one of the core parts of new energy vehicles, the motor gearbox drive assembly has an important impact on the layout of new energy vehicle industry. The motor gearbox drive assembly of new energy vehicle has the characteristics of high rotation speed and high power density, and has high requirements for reliability, cooling and lubrication. At present, the cooling of motor mainly depends on the circulating cooling fluid in the water jacket to cool the stator, while the cooling of windings depends on natural heat dissipation without being directly cooled, so the motor cannot run for a long time at maximum power. Moreover, the cooling of the gearbox depends on air cooling, and the cooling effect is poor. Especially in the high rotation speed range, the temperature rises very fast, which tend to cause the early failure of internal parts.

At the same time, the end customers' requirements for the mileage and performance of the whole vehicle become increasingly higher, and the electric drive system is required to have good power performance and smoothness. When the torque density is improved, it is urgent to design a set of efficient cooling system to meet the development needs of the market.

### SUMMARY

In view of the above problems, the present disclosure is proposed to provide an electric drive assembly with oil/water dual cooling and a new energy vehicle that solve or at least partially solve the above technical problems.

In order to achieve the above object, the present disclosure adopts the following technical solutions.

An aspect of the present disclosure provides an electric drive assembly with oil/water dual cooling, wherein

the electric drive assembly comprises a motor module, a gearbox module, a water cooling module and an oil cooling module;

the motor module comprises a motor housing, a motor shaft and a stator;

the gearbox module comprises a gearbox housing and a first rotating shaft of gearbox, and the gearbox housing is disposed at a rear end of the motor housing;

the water cooling module comprises a motor water jacket and a heat sink, the motor water jacket is sleeved on the motor housing, an upper part of the motor water jacket is provided with a first water inlet, a rear end of a lower part of the motor water jacket is provided with a first water outlet, the heat sink is disposed at the lower end of the gearbox housing, and a front end and a rear end of the heat sink are respectively provided with a second water inlet and a second water outlet;

the oil cooling module comprises an oil conveying device, an oil conveying passage and an oil return passage, the oil conveying device is disposed at a bottom of the gearbox housing, the oil conveying passage is communicated with an inner cavity of the motor housing and an inner cavity of the gearbox housing, and the oil return passage is disposed at a bottom of the motor housing.

Optionally, the oil conveying device is one or more gears, and/or the oil conveying device is one or more nozzles.

Optionally, the oil conveying passage comprises a first oil conveying passage, and the first oil conveying passage comprises a first oil inlet, a first oil passage, a motor front end oil passage and a motor front end shaft inner hole; the first oil inlet is disposed on a front end face of the gearbox housing above the motor housing, the first oil passage is disposed above the motor housing and is communicated with the motor front end oil passage and the motor front end shaft inner hole, and a bottom of the motor front end shaft inner hole is provided with a first oil outlet hole.

Optionally, there are at least two first oil outlet holes, which are respectively disposed at a front side and a rear side of a front end bearing of the motor shaft, and the first oil outlet hole at the rear side corresponds to a front end winding of the motor stator.

Optionally, the oil conveying passage comprises a second oil conveying passage, and the second oil conveying passage comprises a second oil inlet, an inner hole of the first rotating shaft of gearbox and a second oil outlet hole; the second oil inlet is disposed at a rear end of the first rotating shaft of gearbox, the first rotating shaft of gearbox is coaxial with the motor shaft, the second oil outlet hole is disposed in a front part of a rear end bearing of the motor shaft, and a position of the second oil outlet hole is facing a rear winding of the motor stator.

Optionally, the oil conveying passage comprises a third oil conveying passage, and the third oil conveying passage is an oil passage formed by a rear end bearing of the motor shaft.

Optionally, strong magnetic bodies are provided at an oil inlet of the oil conveying passage, a bottom of the gearbox housing and a front side of a rear end bearing of the motor shaft respectively.

Optionally, the water cooling module further comprises an intermediate passage or water pipe disposed at a front end of the gearbox housing, and the intermediate passage or water pipe is communicated with the first water outlet and the second water inlet.

Optionally, the heat sink and the gearbox housing are integrally cast, or the heat sink is installed at the bottom of the gearbox housing.

Another aspect of the present disclosure provides a new energy vehicle comprising any one of the electric drive assemblies with oil/water dual cooling as stated above.

The technical solutions of the electric drive assembly with oil/water dual cooling in the present disclosure have the following advantages:

The electric drive assembly of the present disclosure eliminates the high-speed oil seal on the motor shaft, reduces the number of parts, reduces the cost, avoids the friction loss of the oil seal and improves the efficiency of the assembly.

The oil cooling module in the present disclosure introduces the lubricating oil in the gearbox into the front and rear windings of the motor through multiple passages, so that the temperature of motor windings is reduced and they can run for a long time under the maximum power.

The water cooling module in the present disclosure introduces the motor stator cooling fluid into the heat sink of the gearbox to cool the lubricating oil of the gearbox, so as to ensure that the gearbox has good heat dissipation performance at high rotation speed.

The above is only an overview of the technical solutions of the present disclosure. In order to better understand the technical means of the present disclosure so that it can be implemented according to the contents of the description, and in order to make the above and other objects, features and advantages of the present disclosure more obvious and easy to understand, the specific embodiments of the present disclosure are given below.

### BRIEF DESCRIPTION OF DRAWINGS

By reading the detailed description of the preferred embodiments below, various other advantages and benefits will become clear to a person of ordinary skill in the art. The drawings are only used for the purpose of illustrating the preferred embodiments, and should not be considered as a limitation to the present disclosure. Moreover, throughout the drawings, like reference numerals denote like components. In the drawings:

FIG. 1 is a schematic view of the structure of an electric drive assembly with oil/water dual cooling in an embodiment of the present disclosure; and

FIG. 2 is a perspective view of an electric drive assembly with oil/water dual cooling in an embodiment of the present disclosure.

In the drawings: 1. motor water jacket, 2. motor front winding, 3. motor rear winding, 4. first water inlet, 5. strong magnetic body, 6. gearbox housing, 7. first oil inlet, 8. gearbox cover, 9. rear bearing, 10. strong magnetic body, 11. second oil inlet, 12. oil conveying device, 13. heat sink, 14. second water outlet, 15. first oil passage, 16. motor front end oil passage, 17. front bearing, 18. motor front end shaft inner hole, 19. first oil outlet hole at the front side, 20. first oil outlet hole at the rear side, 21. oil return passage, 22. motor shaft, 23. second oil outlet hole, 24. strong magnetic body, 25. intermediate bearing, 26. first water outlet, 27. oil return port, 28. inner hole of the first rotating shaft, 29. second water inlet, 30. strong magnetic body.

### DETAILED DESCRIPTION

Illustrative embodiments of the present disclosure will be described in more detail with reference to the drawings. Although the drawings show the illustrative embodiments of the present disclosure, it should be understood that the present disclosure can be implemented in various ways and should not be limited by the embodiments disclosed herein. On the contrary, the embodiments are provided for a more thorough and complete understanding of the present disclosure, so as to fully convey the scope of the present disclosure to those skilled in the art.

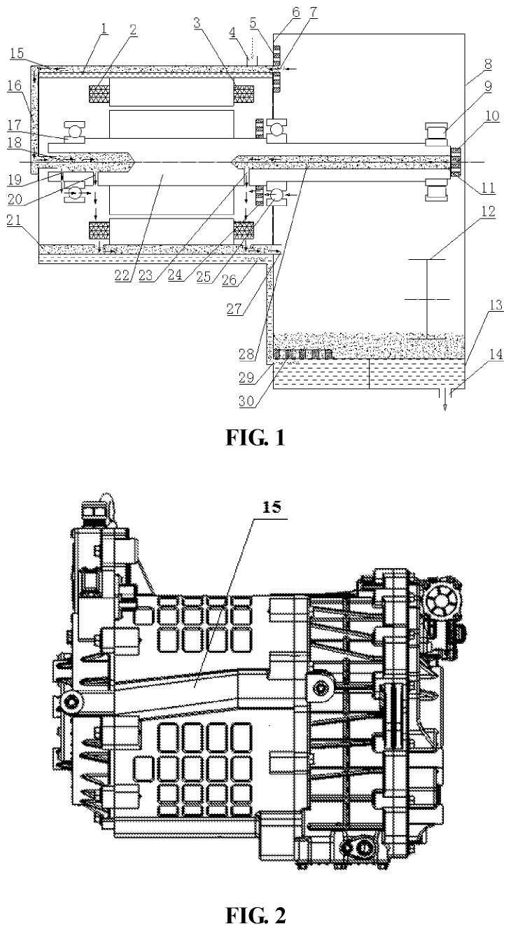

In order to more clearly describe the technical solutions of the present disclosure, it is specially specified that in FIG. 1, the left side is the front end or front side, and the right side is the rear end or rear side.

### First Embodiment

As shown in FIG. 1 and FIG. 2, the first embodiment of the present disclosure discloses an electric drive assembly with oil/water dual cooling, comprising a motor module, a gearbox module, a water cooling module and an oil cooling module. The motor module comprises a motor housing, a motor shaft and a stator, and the stator is provided with windings. The gearbox module comprises a gearbox housing 6 and a first rotating shaft of gearbox, and the gearbox housing 6 is disposed at the rear end of the motor housing. The connection structure of the gearbox housing and the motor housing is shown in FIG. 1 and FIG. 2.

The water cooling module in the embodiment of the present disclosure comprises a motor water jacket 1 and a heat sink 13. The motor water jacket 1 is sleeved on the motor housing. The upper part of the motor water jacket 1 is provided with a first water inlet 7, and the lower part of the rear end of the motor water jacket 1 is provided with a first water outlet 26. The heat sink 13 is disposed at the lower end of the gearbox housing 6, and the front end and the rear end of the heat sink 13 are provided with a second water inlet 29 and a second water outlet 14 respectively. The heat sink can be communicated with the motor water jacket, the cooling fluid in the motor water jacket is introduced into the heat sink through a pipe or a passage provided in the gearbox housing, and the cooling fluid flows back to the vehicle reservoir after circulation. Of course, the heat sink and motor water jacket may also be connected to the vehicle reservoir through pipes respectively.

The oil cooling module in the embodiment of the present disclosure comprises an oil conveying device 12, an oil conveying passage and an oil return passage 21. The oil conveying device 12 is disposed at the bottom of the gearbox housing 6, and the oil return passage 21 is disposed at the bottom of the motor housing. The oil conveying device 12 can lift, splash or spray the lubricating oil from the bottom of the gearbox housing, so as to send the lubricating oil into the oil conveying passage. The oil conveying passage can deliver the lubricating oil in the gearbox housing 6 into the motor housing, so as to realize oil cooling and lubrication of the motor. The oil return passage 21 can return the lubricating oil into the gearbox housing, thereby realizing one circulation of lubricating oil.

A siphon port or an oil holding device may be provided at the inlet of the oil conveying passage to facilitate the lubricating oil to enter inside the oil conveying passage.

Further, in an embodiment, the oil conveying device 12 is one or more gears, and/or the oil conveying device is one or more nozzles. The oil conveying device may be one or more gears, which can splash the lubricating oil to realize oil conveying. The oil conveying device may also be a nozzle, which can be used to spray oil into the passage. Of course, the oil conveying device may also be other devices that drive oil to move.

In a preferred embodiment, the oil conveying passage comprises a first oil conveying passage. The first oil conveying passage comprises a first oil inlet 7, a first oil passage 15, a motor front end oil passage 16 and a motor front end shaft inner hole 18. The first oil inlet 7 is disposed on the front end face of the gearbox housing 6 above the motor housing, the first oil passage 15 is disposed above the motor housing and is communicated with the motor front end oil passage 16 and the motor front end shaft inner hole 18. The bottom of the motor front end shaft inner hole 18 is provided with a first oil outlet hole.

In the present embodiment, the first oil conveying passage mainly comprises a first oil passage 15 on the upper part of the motor housing. The first oil passage 15 may be parallel to the motor main shaft or spirally disposed on the upper part of the motor housing. Alternatively, the first oil passage may be disposed inside the motor water jacket or outside the motor water jacket, so as to further cool the oil. Then, the lubricating oil in the first oil passage 15 is delivered to the motor front end oil passage by gravity, and then the lubricating oil flows into the motor front end shaft inner hole.

In the present embodiment, the first oil passage and the motor front end oil passage may be built-in passages formed on the motor housing by casting, or external oil pipes. The oil pipe connection avoids the complicated oil passage structure on the housing, reduces the casting difficulty of the housing, and is convenient for layout on the whole vehicle.

Further, there are at least two first oil outlet holes, which are disposed at the front side and the rear side of the front end bearing of the motor shaft respectively. The first oil outlet hole at the rear side corresponds to the front end winding of the motor stator. In order to make the lubricating oil delivered by the first oil conveying passage cool the motor front end bearing and the stator front end winding coil, at least two first oil outlet holes or at least two groups of first oil outlet holes are provided on the front end of the motor shaft, which are disposed at the front and rear sides of the front end bearing of the motor shaft respectively. The oil outlet hole at the front side can guide the oil into the front end bearing, and the oil outlet hole at the rear side can face the stator front end winding, When the motor shaft rotates, due to the action of centrifugal force, the lubricating oil in the motor front end shaft inner hole will be sprayed out through the first oil outlet holes, so as to cool the winding.

In an embodiment, the oil conveying passage further comprises a second oil conveying passage. The second oil conveying passage comprises a second oil inlet 11, an inner hole 28 of the first rotating shaft of gearbox, and a second oil outlet hole 23. The second oil inlet 11 is disposed at the rear end of the first rotating shaft of gearbox. The first rotating shaft of gearbox is coaxial with the motor shaft. The second oil outlet hole 23 is disposed at the front side of a rear end bearing of the motor shaft, and the position of the second oil outlet hole 23 is facing a rear winding 3 of the motor stator.

The second oil conveying passage delivers the lubricating oil into the motor housing through the first rotating shaft of gearbox that is coaxial with the motor main shaft. The first rotating shaft of gearbox is hollow and extends at least to a position of the motor shaft at the rear winding of the stator. Similarly, due to the action of centrifugal force, the lubricating oil is sprayed out through the second oil outlet hole, so as to cool the rear winding of the motor stator.

In the present embodiment, the motor shaft and the first rotating shaft of gearbox are designed to be coaxial, which improves the transmission efficiency, simplifies the structure of the electric drive assembly, and reduces the design and manufacturing costs.

In an embodiment, the oil conveying passage comprises a third oil conveying passage, and the third oil conveying passage is an oil passage formed by a rear end bearing 25 of the motor shaft. The third oil conveying passage is a passage for cooling and lubricating the rear end bearing of the motor shaft.

Preferably, strong magnetic bodies are provided at an oil inlet of the oil conveying passage, the bottom of the gearbox housing 6 and the front side of the rear end bearing 25 of the motor shaft respectively. The purpose of providing the strong magnetic bodies is to adsorb the iron filings in the lubricating oil, so as to purify the lubricating oil and reduce the damage to the bearing.

In an embodiment, the water cooling module further comprises an intermediate passage or water pipe disposed at the front end of the gearbox housing 6. The intermediate passage or water pipe is communicated with the first water outlet 26 and the second water inlet 29. The motor water jacket and heat sink 13 are connected in series through the intermediate passage or water pipe disposed on the gearbox housing.

In an embodiment, the heat sink 13 and the gearbox housing 6 may be cast integrally. Alternatively, the heat sink 13 may be regarded as a separate part and installed at the bottom of the gearbox housing 6.

To sum up, the present disclosure discloses an electric drive assembly with oil/water dual cooling. The electric drive assembly comprises a motor module, a gearbox module, a water cooling module and an oil cooling module. The motor module comprises a motor housing, a motor shaft and a stator. The gearbox module comprises a gearbox housing and a first rotating shaft of gearbox, and the gearbox housing is disposed at a rear end of the motor housing. The water cooling module comprises a motor water jacket and a heat sink, the motor water jacket is sleeved on the motor housing, an upper part of the motor water jacket is provided with a first water inlet, a lower part of a rear end of the motor water jacket is provided with a first water outlet, the heat sink is disposed at a lower end of the gearbox housing, and a front end and a rear end of the heat sink are respectively provided with a second water inlet and a second water outlet. The oil cooling module comprises an oil conveying device, an oil conveying passage and an oil return passage, the oil conveying device is disposed at a bottom of the gearbox housing, and the oil return passage is disposed at a bottom of the motor housing. In this technical solution, the lubricating oil in the gearbox is introduced into the front and rear windings of the motor through multiple passages of the oil cooling module, the cooling performance of the motor is improved, the motor shaft oil seal is not needed, the cost of the drive assembly is reduced and the transmission efficiency is improved. Moreover, in this technical solution, the motor housing is cooled through the motor water jacket of the water-cooling module, and the lubricating oil in the gearbox housing is cooled through the heat sink at the bottom of the gearbox, thereby solving the heat dissipation problem when the gearbox of the new energy vehicle operates at high speed constantly, and thus improving the service life and reliability of the gears and bearings.

### Second Embodiment

The present embodiment of the present disclosure also discloses a new energy vehicle comprising any one of the electric drive assemblies with oil/water dual cooling as stated above.

The above are only the specific embodiments of the present disclosure, but the protection scope of the present disclosure is not limited to this. Any person skilled in the art can easily think of changes or substitutions within the technical scope disclosed by the present disclosure, which should be covered by the protection scope of the present disclosure. Therefore, the protection scope of the present disclosure shall be subject to the protection scope of the claims.

1. An electric drive assembly with oil/water dual cooling,
the electric drive assembly comprising:
a motor module including a motor housing, a motor shaft and a stator;
a gearbox module including a gearbox housing and a first rotating shaft of gearbox, and the gearbox housing is disposed at a rear end of the motor housing;
a water cooling module including a motor water jacket and a heat sink, the motor water jacket is sleeved on the motor housing, an upper part of the motor water jacket is provided with a first water inlet, a lower part of a rear end of the motor water jacket is provided with a first water outlet, the heat sink is disposed at a lower end of the gearbox housing, and a front end and a rear end of the heat sink are respectively provided with a second water inlet and a second water outlet; and
an oil cooling module including an oil conveying device, an oil conveying passage and an oil return passage, the oil conveying device is disposed at a bottom of the gearbox housing, the oil conveying passage is communicated with an inner cavity of the motor housing and an inner cavity of the gearbox housing, and the oil return passage is disposed at a bottom of the motor housing.

2. The electric drive assembly according to claim 1, wherein the oil conveying device is at least one of one or more gears and one or more nozzles.

3. The electric drive assembly according to claim 1, wherein the oil conveying passage comprises a first oil conveying passage, and the first oil conveying passage comprises a first oil inlet, a first oil passage, a motor front end oil passage and a motor front end shaft inner hole;
the first oil inlet is disposed on a front end face of the gearbox housing above the motor housing, the first oil passage is disposed above the motor housing and is communicated with the motor front end oil passage and the motor front end shaft inner hole, and a bottom of the motor front end shaft inner hole is provided with a first oil outlet hole.

4. The electric drive assembly according to claim 3, wherein there are at least two first oil outlet holes, which are disposed at a front side and a rear side of a front end bearing of the motor shaft respectively, and the first oil outlet hole at the rear side corresponds to a front end winding of the motor stator.

5. The electric drive assembly according to claim 1, wherein the oil conveying passage comprises a second oil conveying passage, and the second oil conveying passage comprises a second oil inlet, an inner hole of the first rotating shaft of gearbox and a second oil outlet hole;
the second oil inlet is disposed at a rear end of the first rotating shaft of gearbox, the first rotating shaft of gearbox is coaxial with the motor shaft, the second oil outlet hole is disposed in a front part of a rear end bearing of the motor shaft, and a position of the second oil outlet hole is facing a rear winding of the motor stator.

6. The electric drive assembly according to claim 1, wherein the oil conveying passage comprises a third oil conveying passage, and the third oil conveying passage is an oil passage formed by a rear end bearing of the motor shaft.

7. The electric drive assembly according to claim 1, wherein strong magnetic bodies are provided at an oil inlet of the oil conveying passage, a bottom of the gearbox housing and a front side of a rear end bearing of the motor shaft respectively.

8. The electric drive assembly according to claim 1, wherein the water cooling module further comprises an intermediate passage or water pipe disposed at a front end of the gearbox housing, and the intermediate passage or water pipe is communicated with the first water outlet and the second water inlet.

9. The electric drive assembly according to claim 1, wherein the heat sink and the gearbox housing are integrally cast, or the heat sink is installed at the bottom of the gearbox housing.

10. A new energy vehicle, comprising the electric drive assembly with oil/water dual cooling according to claim 1.

11. The new energy vehicle according to claim 10, wherein the oil conveying device is at least one of one or more gears and one or more nozzles.

12. The new energy vehicle according to claim 10,
wherein the oil conveying passage comprises a first oil conveying passage, and the first oil conveying passage comprises a first oil inlet, a first oil passage, a motor front end oil passage and a motor front end shaft inner hole, and
wherein the first oil inlet is disposed on a front end face of the gearbox housing above the motor housing, the first oil passage is disposed above the motor housing and is communicated with the motor front end oil passage and the motor front end shaft inner hole, and a bottom of the motor front end shaft inner hole is provided with a first oil outlet hole.

13. The new energy vehicle according to claim 12, wherein there are at least two first oil outlet holes, which are disposed at a front side and a rear side of a front end bearing of the motor shaft respectively, and the first oil outlet hole at the rear side corresponds to a front end winding of the motor stator.

14. The new energy vehicle according to claim 10,
wherein the oil conveying passage comprises a second oil conveying passage, and the second oil conveying passage comprises a second oil inlet, an inner hole of the first rotating shaft of gearbox and a second oil outlet hole, and
wherein the second oil inlet is disposed at a rear end of the first rotating shaft of gearbox, the first rotating shaft of gearbox is coaxial with the motor shaft, the second oil outlet hole is disposed in a front part of a rear end bearing of the motor shaft, and a position of the second oil outlet hole is facing a rear winding of the motor stator.

15. The new energy vehicle according to claim 10, wherein the oil conveying passage comprises a third oil conveying passage, and the third oil conveying passage is an oil passage formed by a rear end bearing of the motor shaft.

16. The new energy vehicle according to claim 10, wherein strong magnetic bodies are provided at an oil inlet of the oil conveying passage, a bottom of the gearbox housing and a front side of a rear end bearing of the motor shaft respectively.

17. The new energy vehicle according to claim 10, wherein the water cooling module further comprises an intermediate passage or water pipe disposed at a front end of the gearbox housing, and the intermediate passage or water pipe is communicated with the first water outlet and the second water inlet.

18. The new energy vehicle according to claim 10, wherein the heat sink and the gearbox housing are integrally cast, or the heat sink is installed at the bottom of the gearbox housing.
